(19) United States
(12) Patent Application Publication
(10) Pub. No.: US 2017/0279905 A1
(43) Pub. Date: Sep. 28, 2017

(54) INFLUENCE ANALYSIS OF INTERACTIVE CONTENT

(71) Applicant: Jive Software, Inc., Portland, OR (US)

(72) Inventors: Udit J. Shah, Fremont, CA (US); Tomas Jonasson, San Francisco, CA (US); Jayson Barley, Clatskanie, OR (US); Chris Liddell, West Linn, OR (US)

(73) Assignee: Jive Software, Inc.

(21) Appl. No.: 15/080,287

(22) Filed: Mar. 24, 2016

(51) Int. Cl. H04L 29/08; H04L 12/18; G06F 3/0484

(52) U.S. Cl. CPC H04L 67/22; G06F 3/0484; H04L 12/1822

(57) ABSTRACT

Technology for analyzing interactive content is disclosed. In one example, a method is used for providing influence analysis of the interactive content. The method can include determining a base influence score of a first user based at least on types and quantities of the first-user-generated content items. The base influence score can be dampened to account for self-referential content items within the first-user-generated content items. The method can include determining an interactive influence score of the first user based on other-user-generated content items descending from the first-user-generated content items. The method can include combining the base influence score and the interactive influence score to create an influence score of the first user.

### BACKGROUND

Collaborative software platforms are programs that enable a user of the software to contribute content that can be viewed by and commented on by users from within a community of users. Collaborative software can enable users of the software to connect, share ideas, make decisions, and stay informed. As one example, a collaborative software platform can enable employees of an enterprise to solve problems and explore design decisions faced by the enterprise. For example, one employee may start a discussion thread related to a design decision that the employee is attempting to solve. Other employees may provide suggestions to the employee by adding comments to the discussion thread. Using the software may enable a wider variety of participants to participate in and contribute to the decision-making process as compared to ad hoc conversations and/or meetings among limited numbers of employees. Thus, an enterprise that uses the collaborative software platform can potentially increase the flow of information and increase creativity and productivity among its employees.

However, obtaining a cohesive view of the information captured by the collaborative software platform can be challenging. For example, the information may be distributed across a large number of pages of the software and the information can be continually changing as users add new content. Additionally, the relationship of content items to each other and the interactions between the users may be relatively unstructured since contributions are not centrally planned. Thus, computational tools for extracting and analyzing the information captured by the collaborative software platform may be desirable.

### BRIEF DESCRIPTION OF THE DRAWINGS

FIG. 1 is a system diagram showing an example architecture for influence analysis of interactive content.

FIG. 2 illustrates an example page of a collaborative software application, the page including multiple content items generated by multiple users.

FIG. 3 illustrates an example data structure corresponding to the page of FIG. 2.

FIG. 4 illustrates an example set of weights for various types of content items.

FIG. 5 illustrates an example data structure corresponding to a community of users.

FIG. 6 illustrates an example method for analyzing activity of a user of content items.

FIG. 7 illustrates an example page for receiving search criteria and displaying relative influence of users from a community of users.

FIG. 8 illustrates an example method for analyzing influence of a user of content items.

FIG. 9 depicts a generalized example of a suitable computing environment in which the described innovations may be implemented.

### DETAILED DESCRIPTION

### OVERVIEW

The information collected using a social media or collaborative software platform can be analyzed to determine an influence ranking of users of the platform. For example, determining the influence ranking can include measuring a level of activity of each of the users of the collaborative software platform. In one solution, an amount of content (such as blog posts) created by a user can be used as an indication of an amount of influence of the user within the community. However, merely counting an amount of content contributed by the user can overstate the user's current influence if the user has been in the community relatively longer than other users since the user may have had considerably more time to contribute content. Furthermore, merely counting an amount of content contributed by the user does not account for whether and how other users use the contributed content.

As described herein, computational tools can be used to analyze contributed content and a structure of interactions within a collaborative software platform. For example, users or members of a community of users can contribute content, such as text input, to a page displayed by the software platform. Other users of the community can respond to the content, such as by viewing the content, liking the content, sharing the content, downloading the content, or commenting on the content. The content and the responses to the content can be recorded in a database along with usage information about the content. For example, for each content item, a time of creation, an author, and references to additional content generated in response to the original content can be recorded in the database.

The content and interactions stored within the database can be analyzed to determine influence of members within the community of members using the collaborative software platform. The content and interactions can be analyzed within a specified time period to potentially remove volume biases of older users. The content and interactions can be filtered so that only content pertaining to a particular subject matter is analyzed. For example, a community of users can be selected based on a time period and/or a set of search criteria. An individual user's content contributions and interactions with other users can be collectively regarded to determine an influence score for the individual user. Scores can be calculated for the community of users so that the scores can be compared and the users with the most and/or least influence can be identified. Users with relatively more influence can be contacted for advice and/or selected for leadership roles within the community. Users with relatively less influence can be contacted to determine how these users can be better engaged within the community.

By using computational tools to analyze contributed content and the interactions generated by the content, the analysis can occur in near real-time which can enable accurate reporting of the results and trend analysis. For example, the community of users may include large numbers of users (e.g., 1,000's of users or more) and the content can be rapidly changing, such as when controversial topics are introduced. Using the near-real-time analysis can enable an accurate snapshot of influence at a given point in time. These snapshots in time can be compared to identify trends and the information can be acted upon in a prompt manner.

An influence score for a user can include two components, a base influence and an interaction or comment/reply influence. The base influence can be determined by using a weighted sum model (WSM). According to this model, each event that a member engages in can be assigned a weight based on a relative impact of the event. Example events can include creating new content, commenting on content, liking content, and downloading content. Creating new content may have more impact than liking content and so creating content can be given a higher weight than liking content, for example. Generally, the base influence for the user can be determined by multiplying the weight of each event performed by the user by the total number of events of a given event type, and adding the weighted sums. In particular, a user's base influence can be calculated from the equation:

$$Base Influence = {\sum }_{i = 1}^{n} {W}_{i} {E}_{i}$$

where W is the weight for a given event type and Eᵢ is the number of events of the given event type.

The basic WSM can be modified by adjusting the weights for certain events. For example, the weight for some events can be discounted. As a first specific example, the weight associated with a user repeatedly viewing the same content item can be reduced. If the repeated views happen in quick succession, with no events from other people in between, the extra views can be discounted or completely excluded when calculating an influence score for the content item in question and the author of that content item. As a second specific example, the weight associated with self-referential content items can be reduced. For example, a self-referential content item can be created when a given user likes content that the given user created. A user may be tempted to like his or her own content so that his or her influence score appears larger. By reducing or eliminating the contribution of self-referential content items when calculating the influence score, the score may be less open to manipulation.

The influence score for a user can be calculated by combining the base influence component and the interaction influence component. The interaction influence component for the user can be a measure of the interactions and the quality of interactions created by the content items authored by the user. For example, an interaction can include a commenter entering feedback to the content item in a comment/reply-section below the content item. The interactions can include passive actions, such as viewing the content item, and more active actions, such as liking the content item, sharing the content item, downloading the content item, or commenting on the content item. A quality of the interaction can be used to determine the effect on the interaction component of the influence score. For example, more active actions can be given higher scores. In particular, responding to a content item with a comment can generate a higher score than viewing the content item.

Using the interaction or comment/reply influence component to generate the influence score can potentially increase an accuracy of the influence analysis by taking into account the interactions that occur in response to a content item. For example, a blog post that generates a healthy discussion, as measured by the number of comments generated by the blog post, can be more influential than a blog post that generates only a few comments. If the interaction influence component is not considered, then a blogger having a large number of unread and uncommented on posts may potentially be measured to be more influential than a blogger having fewer posts that are widely read and commented on. Thus, the interaction component can potentially increase the accuracy of the influence analysis.

It should be noted that the content has a hierarchical or recursive nature. For example, a first content item created by a first author can be a blog post. A second content item created by a second author can be a comment to the blog post. Authoring the first content item can increase the base influence component of the first author, and receiving the second content item as a comment can increase the interactive influence component of the first author. Authoring the second content item can increase the base influence component of the second author. Thus, the second content item can increase the influence score of both the first author (via the interactive component) and the second author (via the base component).

Some comments may be more influential than other comments. For example, some comments may be more likely to be read and thus can have more influence compared to comments that are less likely to be read. The placement of a comment within a list of comments can affect the likelihood of the comment being read. For example, the first comment and the last comment of a thread may be more likely to be read than comments in the center of the comments thread. The base score of the commenter can account for the position of the comment. For example, higher scores can be given to comments near the first and last comments and lower scores can be given to the comments farther from the first and last comments.

When scores have been calculated for a community of users, the scores can be compared and the users can be ranked according to their influence scores. The community of users can be all users that use the collaborative software program, or the community of users can be the set of users that have contributed content having a particular subject matter. For example, the content database can be searched for content having the particular subject matter and the most influential users associated with the subject matter can be identified.

### EXAMPLE COMPUTER ARCHITECTURE FOR PERFORMING INFLUENCE ANALYSIS

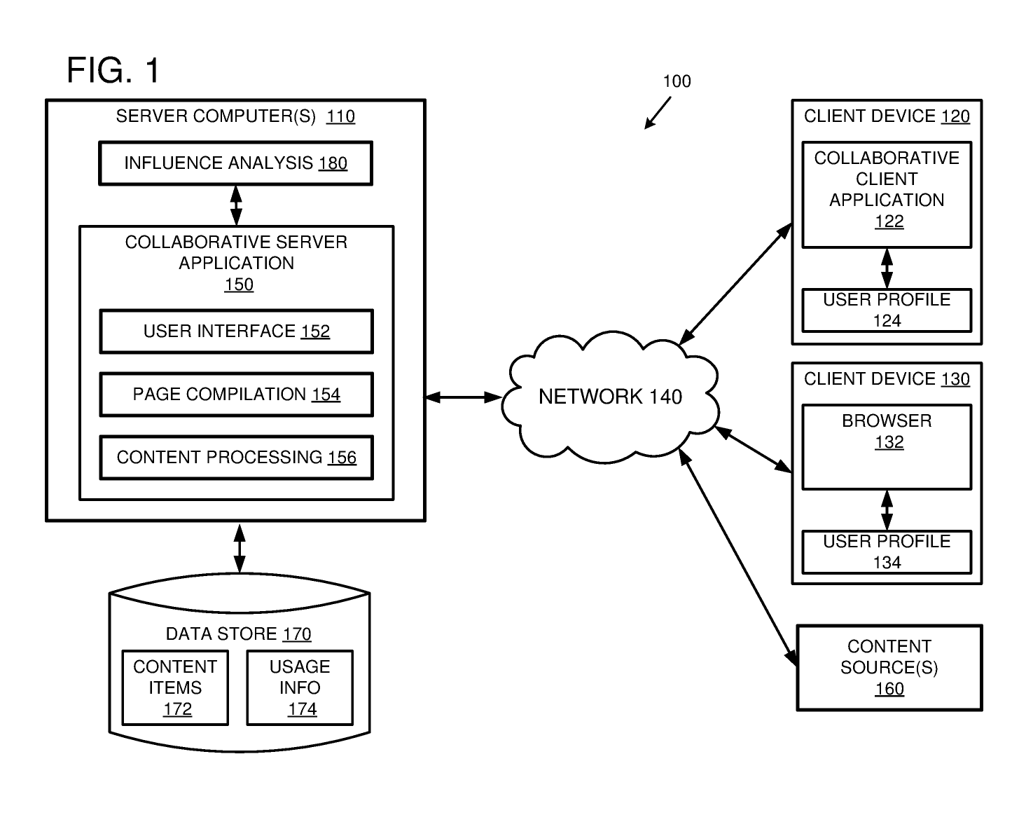

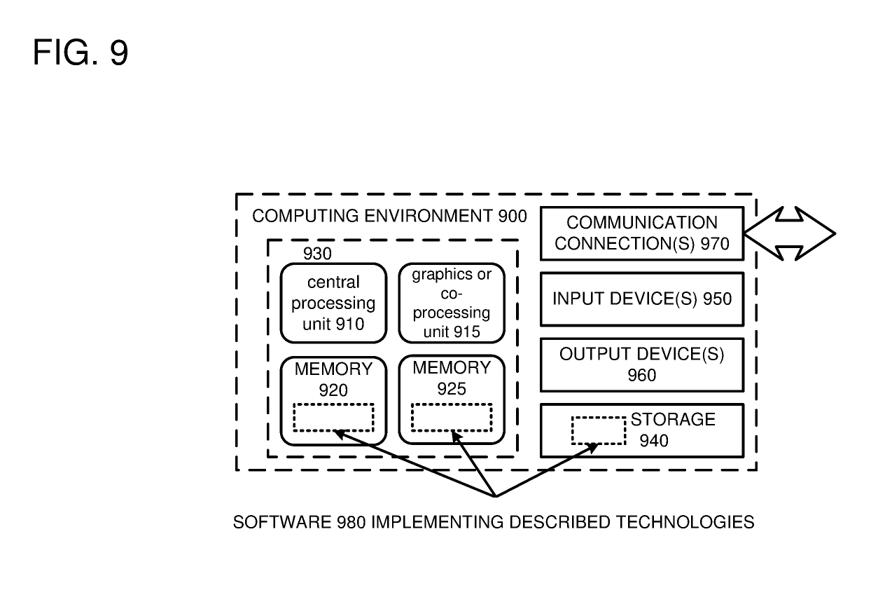

FIG. 1 is a system diagram showing an example architecture 100 for analyzing influence of interactive content. The architecture 100 can be a client-server architecture including one or more server computer(s) 110 and one or more client devices 120 and 130 communicating over a network 140. The one or more server computer(s) 110 can include a computing environment as described further below, with reference to FIG. 9. The network 140 can include a local area network (LAN), a Wide Area Network (WAN), the Internet, an intranet, a wired network, a wireless network, a cellular network, combinations thereof, or any network suitable for providing a channel for communication between the server computer(s) 110 and the client devices 120 and 130. It should be appreciated that the network topology illustrated in FIG. 1 has been simplified and that multiple networks and networking devices can be utilized to interconnect the various computing systems disclosed herein. The client devices 120 and 130 can be a mobile device, a desktop computer, a game console, a set-top box, a laptop computer, a tablet computer, a personal digital assistant, a smartphone, a cellular phone, or any suitable computing environment, for example.

A collaborative software application can be a service or a platform for enabling a community of users to create, share, archive, view and comment on information in an online forum. As one example, the collaborative software application can include a collaborative server application 120 executing on the server computer(s) 110 and a collaborative client application 120 executing on the client device 120. As another example, the collaborative software application can include a collaborative server application 120 executing on the server computer(s) 110 that is accessible using a browser 132 executing on the client device 130. The collaborative client application 120 can include various software modules, such as a user interface module 122, a page compilation module 124, and a content processing module 156. The collaborative software application can present content items and controls to a user using pages that can be displayed on the client devices 120 and 130. For example, the controls can include buttons or menus to add content items, like content items, share content items, and comment on content items. The content items can include content items generated by the community of users and content items obtained from other sources, such as content source(s) 160. For example, content items can be retrieved by one or more of: performing HTTP GET/POST requests, by making a database query to the content source(s) 160 (e.g., by performing a SQL SELECT statement), by requesting a Real Simple Syndication (RSS) feed, by making a Web Services or Simple Object Access Protocol (SOAP) request, by Application Programming Interface (API) calls to the content source(s) 160, by web scraping, and/or by using other suitable information retrieval techniques.

The user interface module 152 can be used to communicate with users and to identify and authenticate the users. Specifically, the user interface module 152 can receive requests for pages and requests to perform actions associated with the pages. The user interface module 152 can respond to the requests for the pages and can perform actions associated with the pages. For example, a user can begin using the collaborative software application by navigating to a start page and/or by logging into the collaborative software application. As a specific example, a user using the client device 130 can navigate to the start page by selecting a uniform resource locator (URL) corresponding to the start page. The URL can be selected by starting the browser 132 (such as when the start page is a home page of the browser) or by interacting with a user interface (UI) of the browser 132, such as by clicking on a hyperlink, entering the URL in an address bar, or selecting the URL from a favorites list. When the user selects the URL of the start page, a request for the start page can be sent to the user interface module 152. The user interface module 152 can transmit the start page to the client device 130 and the start page can be displayed in a window of the browser 132. The start page can provide a prompt for the user to enter credentials, which can be transmitted to the user interface module 152. If the received credentials match stored credentials of a user of the community of users, the user can begin using the collaborative software application. As another example, the user credentials can be stored in a user profile 134 (such as a cookie) and authentication can occur without prompting the user to enter his or her credentials. In addition to providing credentials for a user, the user profile 134 can be used to identify the user when the user creates content and/or interacts with the content generated by other users. As another example, a start page can be displayed on the client device 120 when the collaborative client application 122 is started on the client device 120. In particular, the collaborative client application 122 can transmit a request for the start page and credentials from the user profile 124 and the user interface module 152 can transmit the start page to the collaborative client application 122 for display if the user is authorized.

The page compilation module 154 can be used to assemble and format pages for viewing by the user. For example, the pages can be web pages or other types of pages describing information to be displayed in a graphical user interface. The pages can include content items, functional items (such as controls) for interacting with and/or creating the content items, and other information. For example, the page compilation module 154 can retrieve all content items for a given page, insert any controls and/or status information for the page, and format the page for display. The pages can be described using one or more of various languages, such as HyperText Markup Language (HTML), Cascading Style Sheets (CSS), JavaScript, Extensible Markup Language (XML), or other suitable languages for describing interactive pages. The page compilation module 154 can retrieve content for the pages from a data store 170.

The data store 170 can include computer readable storage used for storing the content items 172 and the usage information 174. The data store 170 can include removable or non-removable storage devices, including magnetic disks, direct-attached storage, network-attached storage (NAS), storage area networks (SAN), redundant arrays of independent disks (RAID), magnetic tapes or cassettes, CD-ROMs, DVDs, or any other medium which can be used to store information in a non-transitory way and which can be accessed by the server computer(s) 110. The data store 170 can include a relational database. A relational database can include a number of tables that each have one or more columns and one or more rows. The content items 172 can include content generated by users of the community, such as text, documents, graphics, photos, videos, and audio recordings. The usage information 174 can include author(s) and creation time of content, viewers of content, content associativity, and other information related to the creation, usage, and relationship of content items. The usage information 174 can be event-based, where an event is created when a content item is viewed or interacted with.

The content processing module 156 can be used for analyzing content items and user interactions with the content items. The results from the analysis can be stored in the usage information 174. For example, a new content item generated by a user can be analyzed to determine a type of the content, an author or the content, a creation time of the content, a relationship to other content items, a relationship to other users, text of the content, and/or a sentiment of the content. As a specific example, a first user can create a content item such as a blog post. The blog post can be analyzed to determine its type (e.g., blog post), its author (e.g., the first user), its creation time, its text, and a sentiment of the text. A second user can view the blog post written by the first user. The view can be analyzed to determine its type (e.g., a view), its author (e.g., the second user), its creation time (e.g., when the view occurred), its relationship to other content items (e.g., it is related to the blog post), a relationship to other users (e.g., it is related to the first user). The content processing module 156 can create separate events for the creation of the blog post and the viewing of the blog post, and the events can be stored in the usage information 174. In particular, for a given event, an event record can be created, the event record can include the results from the analysis, and the event record can be stored in the usage information 174.

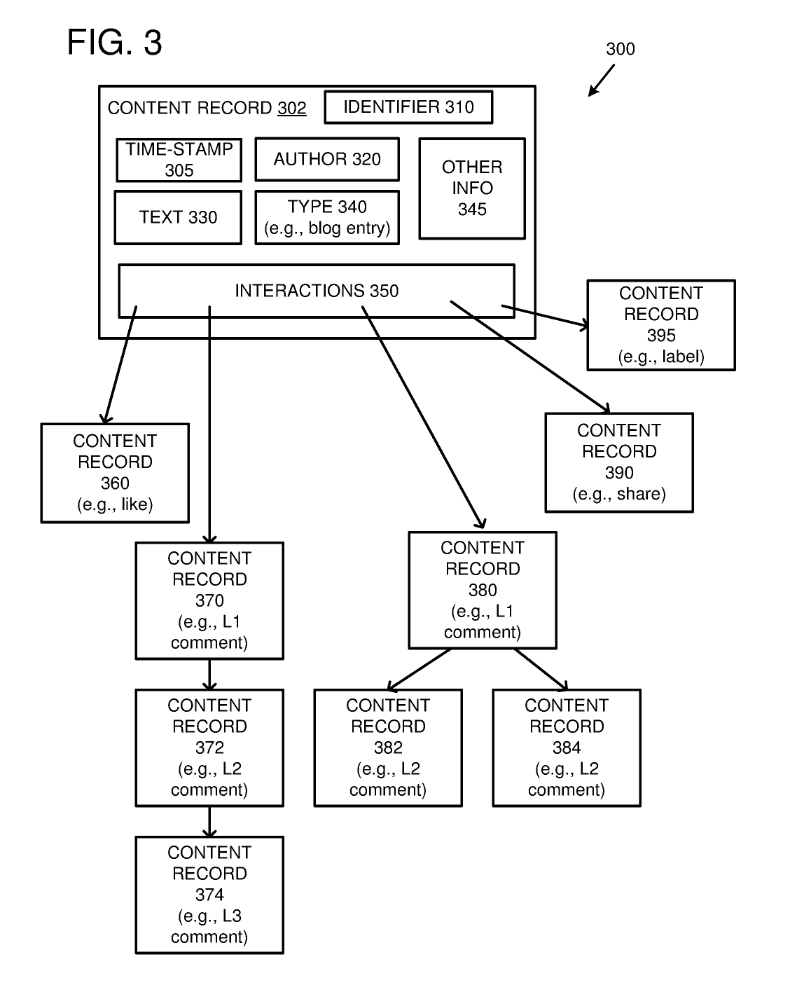

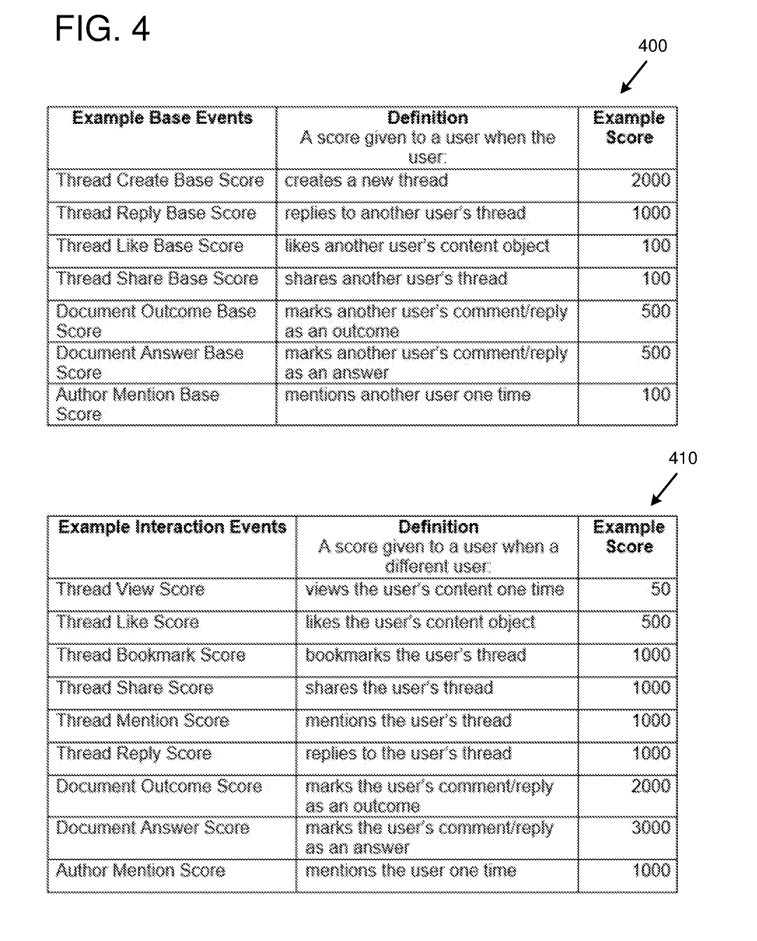

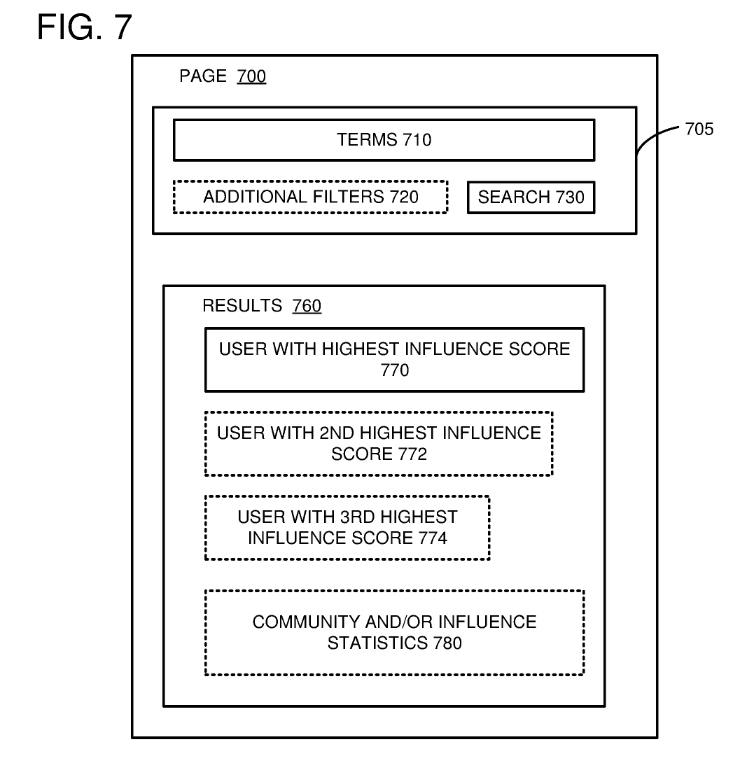

The influence analysis module 180 can be a software module used to analyze content of the collaborative server application 150 to determine an influence of one or more users. The influence analysis module 180 can execute on the server computer(s) 110 (as illustrated) or on the client devices 120 and 130. As an example, the influence analysis module 180 can interface with or be incorporated into the collaborative server application 150 so that the content items 172 and the usage information 174 can be analyzed. In particular, the influence analysis module 180 can provide a page (such as page 700 of FIG. 7) for entering search terms and conditions and/or displaying results of the influence analysis. The search criteria can be used to identify content items and/or a community of users for analysis. As one example, the event records stored in the usage information 174 can be searched. Event records matching the search criteria can be identified and processed to create data structures (such as the data structure 300 of FIG. 3 and the social interaction graph 500 of FIG. 4) describing content and interactions of the users. The data structures can be analyzed to determine the influence of one or more of the users.

For a given identified user, the influence analysis module 180 can generate a base influence score, an interactive influence score, and a combined influence score. The base influence score can be based at least on types and quantities of content items generated by the given user. The base influence score can be adjusted to account for self-referential content items within the content items so that the influence score is less susceptible to manipulation by users attempting to increase their scores. The interactive influence score can be based on content items associated with the given user but not generated by the given user, such as comments or other actions in response to the given user's content. The combined influence score can be generated based on a combination of the base influence score and the interactive influence score. For example, the combined influence score can be the sum of the base influence score and the interactive influence score. Influence scores can be generated for the community of users so that a relative measure of influence for at least one of the users of the community of users can be provided. For example, a ranking of most or least influential users can be provided on page for displaying results of the influence analysis.

As described in more detail herein, the influence analysis module 180 can adjust influence scores based on various factors including characteristics of the users, characteristics of the content items, and usage patterns of the collaborative server application 150. For example, the influence analysis module 180 can profile users based on one or more of: a level in an organization chart of an enterprise, a number of followers, a score based on a social interaction graph, a historical influence, and a tenure in the community of users. As another example, the influence analysis module 180 can account for characteristics of the content items including a position of a content item on a page or within a thread, and a sentiment of a content item. As another example, the influence analysis module 180 can adjust a relative weighting for a type of content item based on a relative frequency of the type of content item occurring.

### EXAMPLE PAGES AND DATA STRUCTURES RELATED TO USER INTERACTIONS

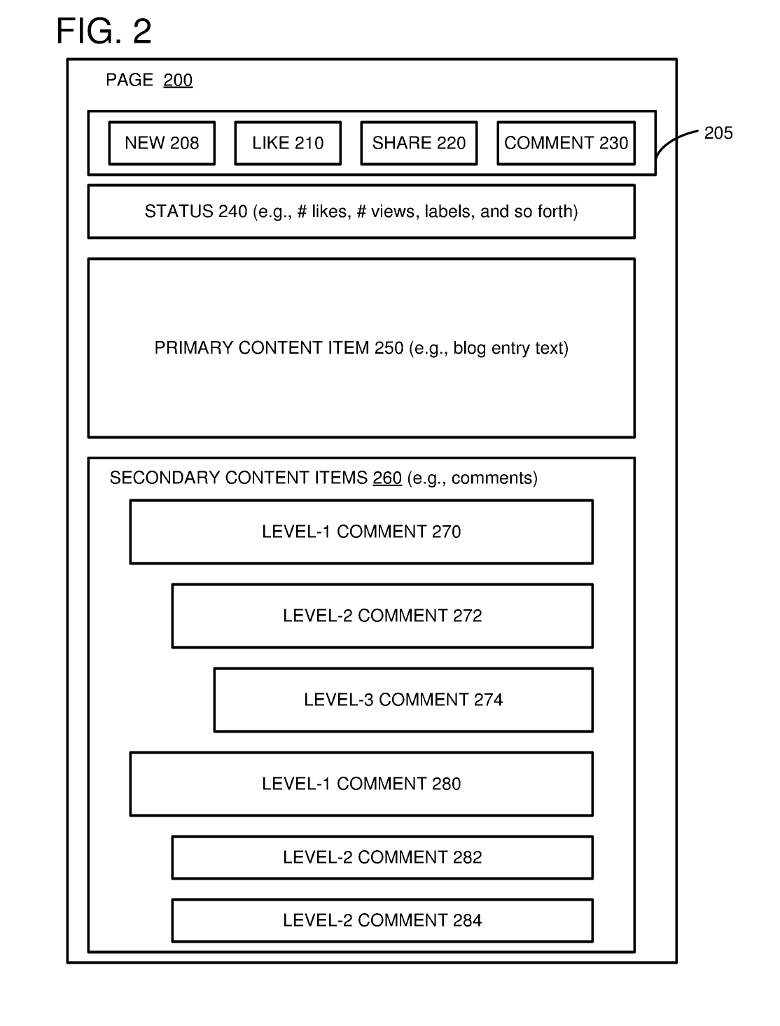

FIG. 2 illustrates an example page 200 of a collaborative software application. The page 200 can include various elements, such as control elements (such as 208, 210, 220, and 230), status information 240, a primary content item 250, and/or secondary content items 260. For example, the control elements can be presented via a menu or a control area 205. The control elements can enable the pages to be interactive so that a user can respond to and/or change the information that is displayed on the page. The control elements can include buttons that perform a predetermined task when the button is pressed. For example, the button can be pressed by clicking on the button with a pointer controlled by a mouse, or by the user physically touching an area where the button is displayed on a touch-sensitive display. As specific examples, the control elements can include a new control button 208, a like control button 210, a share control button 220, and a comment control button 230. The new control button 208 can be used to create a new discussion thread, page, or blog entry. The like control button 210 can be used to indicate that the user has a positive impression of the primary content item 250 displayed on the page 200. The share control button 220 can be used to send a message or email to one or more users with a link to the primary content item 250 displayed on the page 200. The comment control button 230 can be used to add a comment to the secondary content items 260 in response to the primary content item 250 or to the other comments within the secondary content items 260. Other types of control elements are possible, such as a button to add a label the primary content item 250, a button to follow the author of the primary content item 250, a button to bookmark the page 200, and so forth.

The status area 240 can include information that is associated with the content items of the page 200, such as a number of likes of the primary content item 250, a number of views of the primary content item 250, number of shares of the primary content item 250, labels associated with the primary content item 250, an author of the primary content item 250, a creation time and date of the primary content item 250, and a time and date of the last update of the page 200.

The primary content item 250 can be created by a user in response to the user clicking the new control button 208. The primary content item 250 can include various types of content, such as a discussion thread, a document, a video, an audio recording, a graphical presentation, a photo, or a blog entry. As a specific example, the primary content item 250 can be a blog entry. The blog entry can be created when the user clicks on the new control button 208 and enters text in a text entry box that is presented to the user. When the user finishes entering the blog entry text (such as by clicking a done control button), a page (such as the page 200) and a record can be generated corresponding to the primary content item 250. The record is described in more detail further below with reference to FIG. 3. Users within the community can be notified of the page containing the primary content item 250, such as by receiving a link to the page in search results, a notification stream, an email, or by other notification methods.

The community can interact with each other and the author of the primary content item 250 by performing actions in response to the primary content item 250. For example, the actions can include viewing the page displaying the primary content item 250, following the author of the primary content item 250, and liking, sharing, labelling, bookmarking, and/or commenting on the primary content item 250. The actions can cause a data structure corresponding to the page 200 to be updated and/or cause an event corresponding to the action to be generated. The actions can cause a status and/or an appearance of the page 200 to be updated. For example, liking the primary content item 250 can cause a number of likes of the primary content item 250 to increase by one. The number of likes can be displayed on the page 200, such as in the status area 240. As another example, commenting on the primary content item 250 can cause the comment to appear in the secondary content items 260. The comments can be hierarchical, such that a user can comment in response to the primary content item 250 or in response to a comment within the secondary content items 260. As a specific example, a first level of comments (e.g., level-1 comments 270 and 280) can be directed to the primary content item 250. The first level of comments can be added by a user clicking on the comment control button 230 and adding text at a text entry prompt. A second level of comments (e.g., level-1 comments 270 and 280) can be directed to the first level comments. For example, a level-2 comment 272can be directed to the level-1 comment 270 and the level-2 comments 282 and 284 can be directed to the level-1 comment 280.As one example, a second level comment can be added in response to a user clicking on a comment control button (not shown) embedded in an area of the page where the first level comment is displayed. Additional levels of comments can be added (such as a level-3 comment 274 in response to the level-2 comment 272), up to a maximum predefined depth.

A data structure corresponding to the page 200 can be generated when the primary content item 250 is added using the collaborative software program. The data structure can include references to the information and controls displayed on the page 200. The data structure can be dynamically updated as users interact with the page 200. FIG. 3 illustrates an example data structure 300 corresponding to the page 200 of FIG. 2. The data structure 300 can include a content record 302 corresponding to the primary content item and content records 360-395 corresponding to user interactions with the primary content item.

The data structure 300 can be a graph or tree structure where nodes of the graph are the content records, and edges of the graph represent relationships between the nodes. A tree structure is an acyclic graph having a root node and nodes that are connected to the root or to other nodes of the tree. The nodes can be characterized by a distance between nodes, where the distance can be a number of edges traversed between the nodes of interest. For example, a node that is a distance of one from the root node is directly connected to the root node with one edge. A node that is a distance of two from the root node is indirectly connected to the root node via an intermediate node and two edges. The distances between nodes and a reference node can be compared. A node having a larger distance to a reference node is farther from the reference than another node having a smaller distance to the reference. Conversely, a node having a smaller distance to a reference node is closer to the reference than another node having a larger distance to the reference. A level or depth of the nodes is a distance from the root node. The nodes can be characterized by a hierarchy or organization of the nodes. For example, a parent node is a node that is directly connected to a child node by one edge, where the child node is a distance of one farther from the root than the parent node. The child node can have children and so forth. Generally, a descendent node is a node with a path to an ancestor node, where the path goes only through nodes of monotonically decreasing depth. A child node is a specific type of a descendent node.

As an example of the tree terminology, the content record 302 is the root node of the tree 300 and the content records 360-395 are descendants of the content record 302. The content records 360, 370, 380, 390, and 395 are descendants (specifically children) of the content record 302 and have a distance of one from the content record 302. The content records 382 and 384 are descendants (specifically children) of the content record 380 and have a distance of two from the content record 302. The content record 382 is a descendent of both of the content records 380 and 302. The content record 374 is a descendent of the content records 372, 370, and 302. The content record 374 has a depth of three and so is farther from the root content record 302 than the content record 382 which has a depth of two.

The content record 302 can be generated in response to a user adding a content item to a page. The content record 302 can include fields that describe properties associated with the content item and the author of the content item. For example, the content record 302 can include a time-stamp field 305, an identifier field 310, an author field 320, a text field 330, a type field 340, fields for other information 345, and information about interactions 350 (such as links or references to records of content items that were generated in response to the content item corresponding to the content record 302). The time-stamp field 305 can include a creation time of the content item and/or a time corresponding to the last interaction with the content item. The identifier field 310 can be assigned by the collaborative software application when the content item is generated to distinguish the content record 302 from other content records. The author field 320 can include information about the author of the content item, such as a name, alias, title, and so forth. The text field 330 can include text entered as a post, a comment, or a label. The type field 340 can indicate a type of the content item, such as a blog entry, a like, an L1-comment, an L2-comment, an L3-comment, a share, a label, and so forth. The other information field 345 can be used to describe additional information related to the content item, the page displaying the content item, the author, the community of users, the organization sponsoring or hosting the collaborative software application, and so forth. It should be noted that for ease of illustration, the content record 302 is illustrated in greater detail than the content records 360-395, but the content records 360-395 can have the same or similar fields as for the content record 302.

The content record 302 can include information about interactions 350, such as links or references to other content records that are created when users respond to the content item. For example, the interactions 350 can include references to a content records that are children of the content record 302. As a specific example, the comments from FIG. 2 can be mapped to corresponding records of FIG. 3. In particular, the L1-comment 270 can correspond to the content record 370; the L2-comment 272can correspond to the content record 372; the L3-comment 274 can correspond to the content record 374; the L1-comment 280 can correspond to the content record 380; the L2-comment 282 can correspond to the content record 382; and the L2-comment 284 can correspond to the content record 384. The interactions 350 can capture additional interactivity that may or may not be directly indicated on the page 200. For example, a like of the primary content item 250 can be recorded with a link to the content record 360; sharing the primary content item 250 can be recorded with a link to the content record 390; and labeling the primary content item 250 can be recorded with a link to the content record 395.

As described herein, for a given user, a first score can be generated based on content generated by the given user and a second score can be generated based on content generated by other users in response to the given user's content. The first and second scores can be combined to create a combined score. The scores can be based on types and quantities of content items generated by and/or in response to the given user. FIG. 4 illustrates tables of example scores that can be assigned to various types of content items. In particular, table 400 illustrates example scores that can be assigned to content items generated by the given user and table 410 illustrates example scores that can be assigned to content items generated in response to the given user's content. The scores for the different types of content items can be assigned based on how common the content item is and an amount of activity associated with the content items. For example, viewing content may be both prevalent and easy (e.g., low activity) so a low score can be assigned to views. On the other hand, creating new content may be more rare and more difficult (e.g., high activity) and so a high score can be assigned to creating content. The scores can be predefined by a vendor of the collaborative software application, by an administrator of the community of users, or by a user calculating the score, for example. Alternatively, the scores can be automatically and dynamically adjusted based on usage patterns of the collaborative software application. For example, a number or average frequency of a type of content item can be calculated and the score assigned to the type of content item can be inversely proportional to a relative frequency of the type of content item compared to the other types of content items.

The first score or base score can be generated based on content generated by the given user. Table 400 illustrates example scores that can be assigned to the content items generated by the given user. As a specific example, the given user can be the author of the primary content item 250 of page 200 of FIG. 2. The author can receive 2,000 points for creating the new blog post or thread. The author may have also created other content items (such as other blog posts or comments to other user's content items) which can also receive points and contribute to the base score. However, the base score can be adjusted to account for self-referential content items. For example, if the author creates a second blog post, the author can receive 2,000 additional points. However, if the author replies to or comments on the author's own content item (such as by adding the level-1 comment 270 to page 200), the author can receive an adjusted score for adding the comment. As a specific example, the score assigned to the author can be a fraction (e.g., 10%) of the thread reply base score amount of 1,000. By dampening or discounting self-referential content items, the score may be less susceptible to manipulation by users attempting to increase their scores.

The second score or interactive score can be generated based on content items that are generated in response to content items generated by the given user. Table 410 illustrates example scores that can be assigned to content items generated in response to the given user's content. As a specific example, the interactive score can be generated for the author of the primary content item 250 of page 200 of FIG. 2. In this example, all of the secondary content items are generated by users other than the author. The author can receive: 500 points for the like (e.g., content record 360); 1,000 points for the share (e.g., content record 390); 2,000 points for the primary content item 250 being marked as an outcome (e.g., content record 395); and 1,000 points each for the first level comments (e.g., content records 370 and 380).

The second level and third level comments can be scored the same as the first level comments (e.g., 1,000 points each), or they can be scored differently based on a distance from the primary content item 250. The distance can be based on a level of the comment and/or a creation order of the comment within a level. As one example, the score can be reduced linearly, geometrically, exponentially, or asymptotically as the distance increases. Thus, comments closer (having a smaller distance) to the primary content item 250 can be scored higher than comments farther (having a larger distance) from the primary content item 250. As a specific example, the first level comments can be a distance of one from the primary content item 250, the second level comments can be a distance of two from the primary content item 250, and the third level comments can be a distance of three from the primary content item 250. The second level comments can be assigned 500 points each and the third level comments can be assigned 250 points each. The reduction in points for more distant content items can account for the reduced influence of the primary content item 250 on the generated comment. For example, the second level commenter is likely to be responding directly to the first level commenter and less directly to the author of the primary content item 250.

The total interactive score can be calculated by accounting for all of the content items generated in response to the given user's content. For example, the total interactive score can be the sum of all of the points assigned to content items generated in response to the given user's content. In this example, the interactive score can be 10,500 (500+1,000+2,000+1,000+6*1,000) where all of the comments are weighted equally, and the interactive score can be 8,250 (500+1,000+2,000+1,000+2*1,000+3*500+250) where the comments are reduced based on the level of the comment. As described further below, the scores of the individual content items generated in response to the given user's content can be further scaled or weighted based on properties of the content items and/or the responding user.

The combined score can be generated based on a combination of the base score and the interactive score. For example, the combined score can be the sum of the base score and the interactive score. As another example, the combined score can scale or weight one of the components more heavily, such as by giving more weight to the interactive score compared to the base score. As a specific example, the combined score for the author of the primary content item 250 can be 12,500 (2,000+10,500) where the primary content item 250 is the only content generated by the author and where all of the comments are weighted equally.

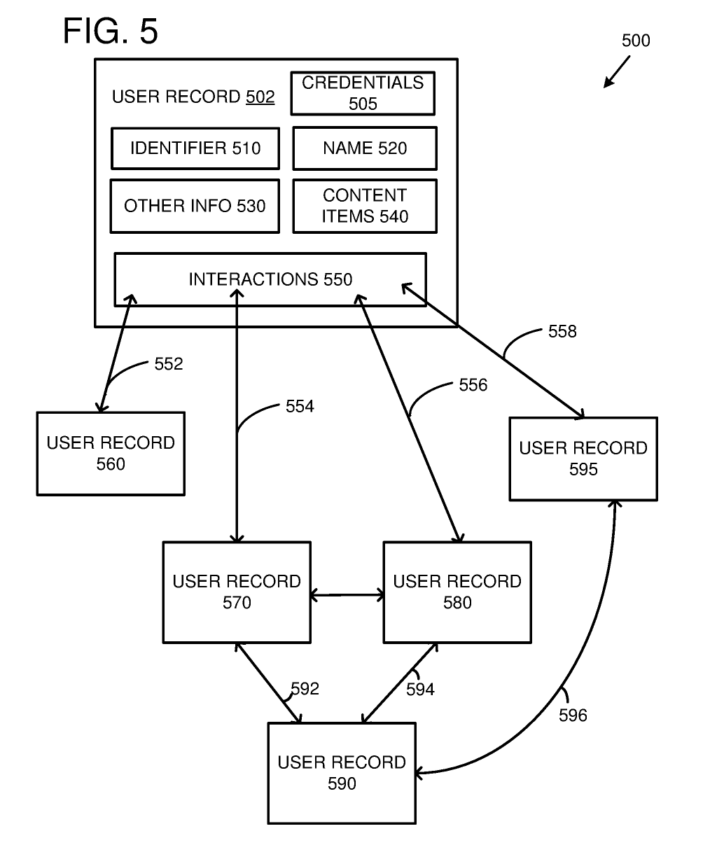

The scores assigned to the individual content items can be scaled or weighted based on properties of the respective authors of the individual content items. One of the properties can be a score based on a social interaction graph. The social interaction graph is a data structure corresponding to a community of users and the interactions that occur between the users. FIG. 5 illustrates an example of a social interaction graph 500.

Nodes of the social interaction graph 500 can be user records (e.g., 502, 560, 570, 580, 590, and 595). The user records can be generated in response to a user being added to the community of users and the user records can be updated in response to interactions occurring among the users. The user records, such as user record 502, can include fields that describe properties associated with each author of content items. For example, the user record 502 can include a credentials field 505, an identifier field 510, a name field 520, fields for other information 530, information about content items generated by the user 540 (such as links or references to records of content items that were generated by the user), and information about interactions 550 (such as links or references to user records corresponding to users that have interacted with the user).

The credentials field 505 can include valid login credentials of the user. When a user logs into the collaborative software program with credentials, the presented credentials can be compared to the stored credentials to authenticate the user. The identifier field 510 can be assigned by the collaborative software application when the user record is generated to distinguish the user record 502 from other user records. The name field 520 can include information about the user, such as a name, alias, title, and so forth. The other information field 530 can include miscellaneous information about a user such as a time and date the user joined the community, a time and date the user last logged into the application, and so forth. The information about content items generated by the user 540 can include links or references to records of content items that were generated by the user. The information about interactions 550 can list or provide links or references to user records corresponding to users that have interacted with the user. It should be noted that for ease of illustration, the user record 502 is illustrated in greater detail than the user records 560-595, but the user records 560-595 can have the same or similar fields as for the user record 502.

Edges (e.g., 552, 554, 556, and 558) of the social interaction graph 500 can be links to user records corresponding to users that have had an interaction on the collaborative software application. As a specific example, the user corresponding to user record 502 has had interactions with the users corresponding to user records 560, 570, 580, and 595 as indicated by the edges 552, 554, 556, and 558 respectively. Each edge can have a score or weight based on a quantity and quality of interactions between the users connected by the edge. For example, if the user corresponding to user record 502 (abbreviated as user 502) and the user 560 have more and higher quality interactions than the user 502 and the user 570, then the edge 552 will have a higher score than the edge 554. A score for each interaction can be retrieved from a table, such as the table 410 of FIG. 4. The scores for each of the interactions can be attributed to the appropriate edges and accumulated with the other scores of the edge. As a specific example, if the user 560 comments on a post by the user 502, then the score for the edge 552 can be increased by the thread reply score (e.g., 1,000). If the user 560 also likes the post by the user 502, then the score for the edge 552 can be further increased by the thread like score (e.g., 500). If the user 502 views a post by the user 580, then the score for the edge 556 can be increased by the thread view score (e.g., 50).

Calculating the user's score based on the social interaction graph can include summing the scores of each edge for the user. Thus, calculating the score for the user 502 can include adding the scores for the edges 552, 554, 556, and 558 and calculating the score for the user 590 can include adding the scores for the edges 592, 594, and 596. The scores can be weighted based on a property of the user to increase or decrease the score. Scores can be calculated for all of the users of a community and the scores can be compared to give a relative ranking of the interactivity of the users.

### EXAMPLE METHODS FOR ANALYZING INFLUENCE

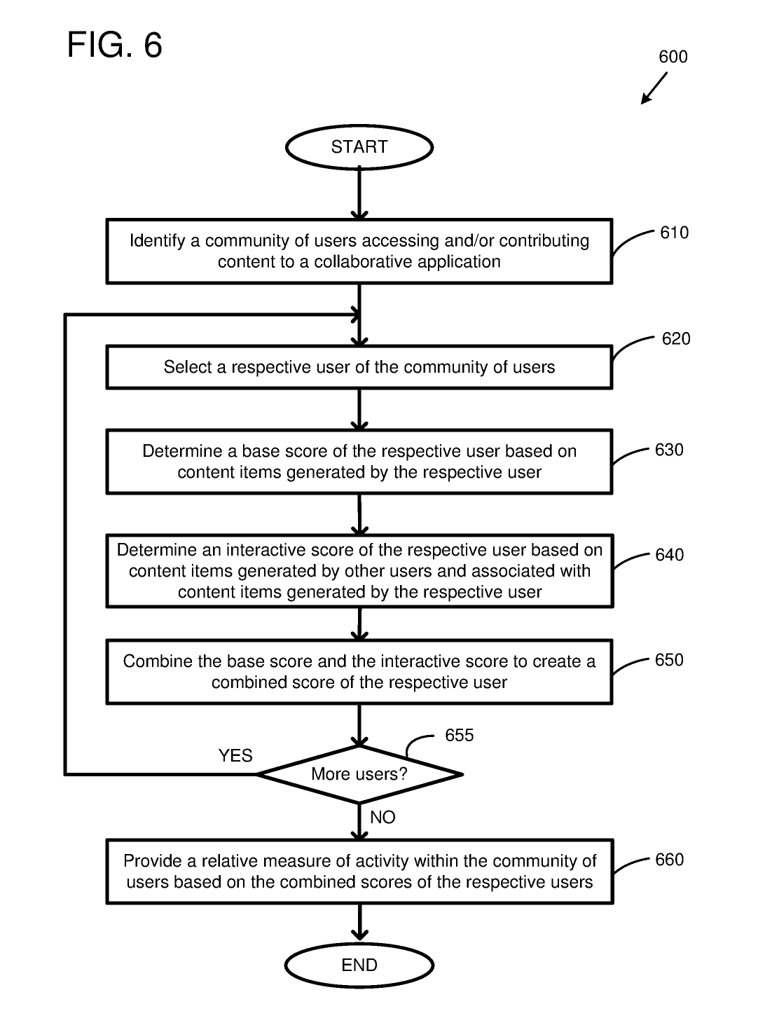

FIG. 6 illustrates an example method 600 for analyzing an amount of activity of users of a collaborative software platform. The amount of activity of a respective user and the amount of activity generated in response to the respective user's actions can be indicative of an influence of the respective user within a community of users.

At 610, a community of users that access and/or contribute content to a collaborative application can be identified. For example, the community of users can be all of the users that are authorized to use the collaborative software platform. As another example, the community of users can be a subset of all of the authorized users, such as the users that meet a given search criteria, or the users that are associated with content items that meet a given search criteria. When the community of users is identified, an activity score can be calculated for each of users, such as by looping through all users of the community of users. For example, the loop body can begin at 620 and end at 650.

At 620, a respective user of the community of users can be selected. When the loop is complete, all of the users of the community of users will be selected.

At 630, a base score of the respective user can be determined based on content items generated by the respective user. For example, the base score can be based on types and quantities of the respective-user-generated content items. In particular, the base score can be a weighted sum of events caused by the user generating content items. The weight assigned for each content item generated by the user can be based on the type of content item that is generated. For example, table 410 of FIG. 4 lists an example set of weights that can be assigned for different types of content items. The value of the weights can be static or can be dynamically adjusted over time. For example, the weights for a given type of content item can be inversely proportional to a relative frequency of the given type of content item.

The weight for a particular content item or event can be adjusted based on one or more properties of the content items and/or the respective user. As a specific example, the weight for the particular event can be multiplied by one or more scaling factors accounting for one or more properties of the content items and/or the respective user. The scaling factor corresponding to most properties can have a moderate effect on the weight for the particular event, such as by changing the weight within a range of about +/− 10% (e.g., the weight can be from about 90% to 110% of the starting weight). However, the scaling factor corresponding to self-referential content items can be much larger so that the effect of the self-referential content items can be dampened to reduce or negate activities based on self-promotion, evangelizing, and manipulations of the scoring system. As one example, the weight corresponding to self-referential content items can be scaled to about 10% of the beginning weight for the particular type of content item. As another example, the weight corresponding to self-referential content items can be set to zero so that the self-referential content items are completely removed from the score.

Scaling factors can account for properties of the respective user, such as a level in an organization chart, a number of followers, a score based on a social interaction graph, the respective user's lifetime influence, and the respective user's tenure within the community of users. The organization chart can describe the hierarchical structure of an enterprise. A person higher on the chart (closer to a decision maker or leader) may have more influence than a person lower on the chart. The scaling factor can account for the difference in influence. For example, an employee at a higher level can be scaled higher than an employee at a lower level. Similarly, a user with more followers can have more influence and so a user with more followers can be scaled higher than user with fewer followers. Similarly, a user with a higher score based on a social interaction graph may have more influence and so a user with a higher score can be scaled higher than user with a lower score. The social interaction graph can be constructed, and the users can be scored, as described above with reference to FIG. 5, for example.

A scaling factor can be based on a lifetime influence of a user. For example, the activity or influence scores for the community of users can be calculated at regular intervals. The lifetime influence can be calculated from the historical calculations, such as by taking a rolling average of the historical scores. As one example, the lifetime influence can be an exponentially decaying weighted average of the historical scores. The lifetime influence scores of the community of users can be analyzed using statistical methods. For example, an average or median value of the lifetime influence score can be calculated and the users can be ranked or banded based on how far their score is from the average. In particular, the users can be grouped within standard deviations from the average, and users having lifetime influence scores above the average can be scaled higher based on how many standard deviations they are above the average. Users having lifetime influence scores below the average can be scaled lower based on how many standard deviations they are below the average. Scaling the weight of content items based on lifetime influence scores can potentially account for an influential user lending some of their influence to the content item.

A scaling factor can be based on a tenure of a user. The tenure of the user can be based on how long the user has been part of the community of users. For example, users that have been in the community longer can have larger networks of followers and a greater volume of content than newer users to the community. Posts by less tenured users can take more time to be noticed due to the smaller network and lower volume of content of the less tenured users. The less tenured users can be scaled upward to offset the lack of the network and the more tenured users can be scaled downward to account for the high level of exposure of their posts. The scaling factor for tenure can be a check on the lifetime influence scaling factor and can potentially highlight a less tenured user that is being interacted with despite the lack of a large network.

Scaling factors can account for properties of the content item, such as a position of the content item in relation to other content items and a sentiment of the content item. As one example, a scaling factor can be based on the position of the content item within a list of similar content items. As a specific example, comments near a beginning of the comments section and comments near the end of the comments section can be weighted higher than comments nearer the middle of the comments section. The weighting can be non-linear (such as asymptotic) so that a few comments near the beginning and the end are scaled up and comments in the middle are scaled down. By providing more weight to the comments near the beginning and end of the comments, a user's tendency to read the main post and the first few comments and then skip to the last comments can be accounted for. As another example, a scaling factor can be based on a level of a comment in a hierarchical set of comments. For example, first-level comments can be weighted higher than second- or third-level comments to account for the second- and third-level comments potentially being less important to the main thread.

A scaling factor can account for a sentiment of the content item. For example, a sentiment score can be based on performing natural language processing on the content item. In particular, the words of the content item can be parsed and a given word can be given a score based on the word having a positive, neutral, or negative meaning. As specific examples: positive words can be great, good, love, awesome, and fantastic; negative words can be terrible, lousy, hate, and yuck; neutral words can be the, and, computer, and so forth. Words that are more positive can be given a higher score, for example, great can have a score 1.0 and good can have a score of 0.8; words that are more negative can be given a lower score, for example, awful can have a score −1.0 and bad can have a score of −0.8; words that are more neutral can be given a score near 0. The scores for the words can be accumulated and averaged to get an average sentiment score for the content item.

The scaling factor for sentiment can also take an intensity of the content item into account. The intensity of the content item can be based on performing natural language processing on the content item. In particular, the words and punctuation of the content item can be parsed into tokens and a given token can be given a score based on a meaning of the token. As specific examples: more intense words and punctuation can be all capitals, exclamation points, expletives, and adverbs such as very or extremely; less intense words and punctuation can be periods, commas, and so forth. Tokens that are more intense can be given a higher score, for example, “!!!” can have a score 1.0 and a period can have a score of 0. The scores for the tokens can be accumulated and averaged to get an average intensity score for the content item.

The sentiment can also be determined based on actions of the users. For example, a post with an above average number of views and a below average number of likes or comments may be a controversial post. For example, users may not want to be associated with a highly negative post for fear of repercussions. Thus, a controversial but highly influential post may receive a lower score than a less controversial post. By using the scaling factors for sentiment and intensity, the more controversial posts can be given a boost compared to the less controversial posts. For example, the scaling factor for sentiment can be increased for posts having more negative sentiment scores and high intensity scores.

Summarizing, the base score of the respective user can be determined based on a weighted sum of the content items generated by the respective user. Each content item can be given a starting score based on the type of content which can be adjusted, such as by multiplying the starting score by one or more scaling factors. The scaling factors can be based on one or more properties of the content items and/or the respective user. As a specific example, each of the scaling factors can modify the score within a range of about 90% to 110% of the starting score, except the self-referential scaling factor can dampen the score to about 10% of the starting score. In other words, all scaling factors except for the self-referential scaling factor can be between about 0.9 and 1.1, and the self-referential scaling factor can be about 0.1. As another specific example, each of the scaling factors can modify the score within a range of about 80% to 120% of the starting score, except the self-referential scaling factor can dampen the score to about 20% of the starting score. In other words, all scaling factors except for the self-referential scaling factor can be between about 0.8 and 1.2, and the self-referential scaling factor can be about 0.2.

At 640, an interactive score of the respective user can be determined based on content items generated by other users and associated with content items generated by the respective user. For example, the interactive score can be based on types and quantities of the content items generated by other users in response to the respective-user-generated content. In particular, the interactive score can be a weighted sum of events caused by other users generating content items, where the content items can be descendants of the respective-user-generated content item. The weight assigned for each content item generated by the other users can be based on the type of content item that is generated. For example, table 420 of FIG. 4 lists an example set of weights that can be assigned for different types of content items. The value of the weights can be static or can be dynamically adjusted over time. For example, the weights for a given type of content item can be inversely proportional to a relative frequency of the given type of content item. The weights for the given type of content item can be adjusted by the scaling factors described above that are based on one or more properties of the content items and/or the author of the content item.

At 650, the base score and the interactive score can be combined to create a combined score of the respective user. As one example, the base score and the interactive score can be added to create the combined score. As another example, one of the components of the score can be weighed more heavily than the other component, and then the adjusted component(s) can be added. In particular, the base score can be increased relative to the interactive score to give more weight to generating content, or the interactive score can be increased relative to the base score to give more weight to generating content that creates responses. As specific examples, the base score can be multiplied by 110% before being added to the interactive score; or the interactive score can be multiplied by 110% before being added to the base score.

At 655, it is determined if there are more users within the community of users. If there are more users, the method 600 can continue at 620 so that the body of the loop (620-650) can continue. If scores have been calculated for all of the users within the community of users, the method 600 can continue at 660.

At 660, a relative measure of activity within the community of users can be provided. The relative measure of activity can be based on the combined scores of the respective users. For example, the relative measure of the activity can be a listing of the most or least active users in numerical order as measured by the combined scores. As another example, the relative measure of the activity can be a chart or graph where a size and/or position of an element of the graph is based on the combined scores. As specific examples, the bars of a bar graph can be sized relative to the combined scores or the wedges of a pie chart can be sized relative to the combined scores. By providing the relative measure of activity within the community of users, the most and/or least active users can be identified.

FIG. 7 illustrates an example page 700 for receiving search criteria and displaying relative influence of users from a community of users. For example, the page 700 can be navigated to while using the collaborative software application. As another example, the page 700 can be a page of influence analysis application that is separate from the collaborative software application, but uses data generated by the users of the collaborative software application. The page 700 can include a search area 705 and a results area 760.

The search area 705 can include elements for receiving search criteria. For example, a text entry box (terms 710) can be used to enter terms to be searched. Additional filters 720 can be used to receive search criteria from a radio button, a drop-down menu, or other suitable input element. As a specific example, a time period can be selected from one or more drop-down menus. The time periods can include a range within the last hour, the last four hours, the last twenty-four hours, the last week, the last month, and so forth. The search button control 730 can be used to initiate the search.

The results area 760 can be used to display a relative measure of activity and/or influence within the community of users. For example, the relative measure of activity can be a bar graph that ranks the most influential users as measured by an influence analysis module. As a specific example, a bar 770 corresponding to a user with the highest influence score can be positioned above a bar 772 corresponding to a user with the second highest influence score which can be positioned above a bar 774 corresponding to a user with the third highest influence score. The length of the bars 770, 772, and 774 can be proportional to the combined influence scores of the respective users. The user's name and/or other identifying information can be overlaid on or positioned near the bars 770, 772, and 774 so that the users can be identified. Additional statistics 780 about the community or the influence scores of the community can be displayed. For example, the additional statistics 780 can include a graph showing an activity distribution, a number of people within the community of users, an average number of posts per user, a median number of posts per user, and so forth.

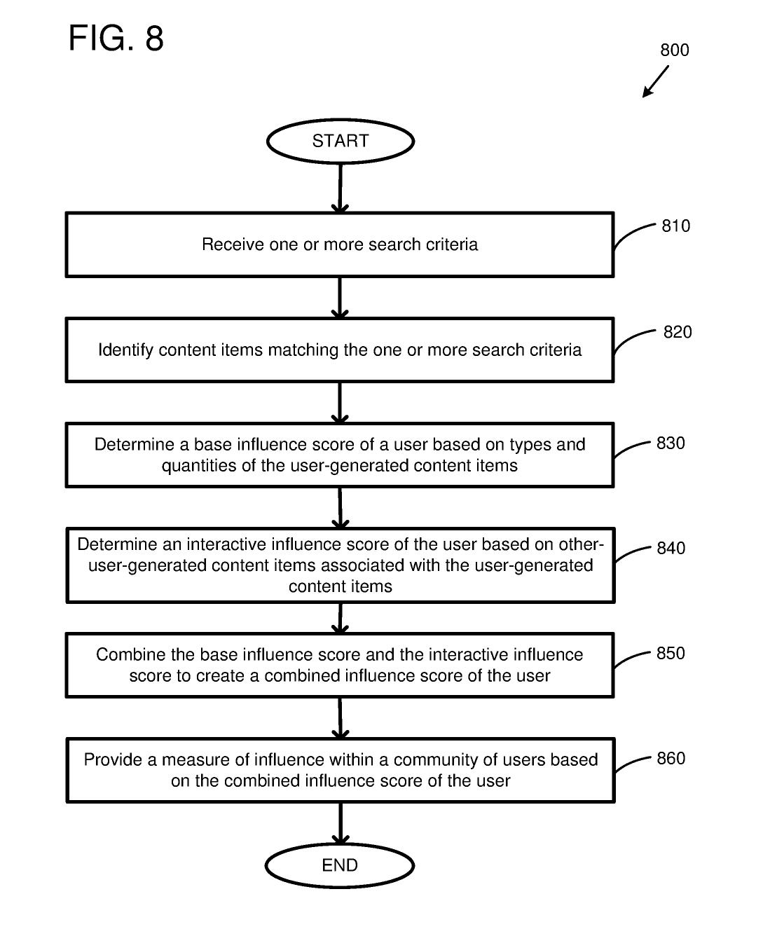

FIG. 8 illustrates an example method 800 for analyzing influence of a user of content items. As one example, the method 800 can be implemented by using a system including an influence analysis module 180, as described above with reference to FIG. 1.

At 810, one or more search criteria are received. For example, the search criteria may be entered via a graphical user interface or received from a script or file. The search criteria can be related to properties of content, users, a time period, or other criteria related to a collaborative software application.

At 820, content items can be identified that match the one or more search criteria. For example, the content items can be identified by searching a list of events using the one or more search criteria. The events can be created in response to users adding and/or responding to content items using the collaborative software application. The identified content items can be processed to create data structures (such as the data structure 300 of FIG. 3 and the social interaction graph 500 of FIG. 4) describing content and interactions of a community of users. The data structures can be analyzed (such as in 830 and 840) to determine the influence of a user.

At 830, a base influence score of the user can be determined based at least on types and quantities of the user-generated content items. For example, the base influence score of the user can be a sum of scaled weights, where each of the weights corresponds to one of the content items generated by the respective user. The value of each weight can be selected based on the type of the content item (such as by selecting the weight from the table 410 of FIG. 4) and scaled by one or more scaling factors (such as described in relation to 630 of FIG. 6). The scaling factors can be based on properties of the content items and/or the users. An additional scaling factor can be used to dampen the base influence score for self-referential content items to potentially reduce manipulation of the scoring system.

At 840, an interactive influence score of the user can be determined based on other-user-generated content items associated with the user-generated content items. As one example, the interactive influence score of the user can be based on other-user-generated content items in response to the user-generated content items. In particular, the other-user-generated content items can be descendants of a user-generated content item as described above with reference to

FIG. 3. The interactive influence score of the user can be a sum of scaled weights, where each of the weights corresponds to one of the descendent content items generated by the other users. The value of each weight can be selected based on the type of the content item (such as by selecting the weight from the table 420 of FIG. 4) and scaled by one or more scaling factors (such as described in relation to 630 of FIG. 6).

At 850, the base influence score and the interactive influence score can be combined to create a combined influence score of the user. As one example, the base influence score and the interactive influence score can be added to create the combined influence score. As another example, one of the components of the score can be weighed more heavily than the other component, and then the adjusted component(s) can be added. In particular, the base influence score can be increased relative to the interactive influence score to give more weight to creating new content, or the interactive influence score can be increased relative to the base influence score to give more weight to creating interactions among the users.

At 860, a measure of influence within a community of users can be provided based on the combined influence score of the user. The relative measure of influence can be based on the combined influence scores of the community of users. For example, the relative measure of influence can be a listing of the most or least influential users in numerical order as measured by the combined influence scores. As another example, the relative measure of influence can be a chart or graph where a size and/or position of an element of the graph is based on the combined influence scores (such as described with reference to the results section 760 of FIG. 7).

### EXAMPLE COMPUTING DEVICES

FIG. 9 depicts a generalized example of a suitable computing environment 900 in which the described innovations may be implemented. The computing environment 900 is not intended to suggest any limitation as to scope of use or functionality, as the innovations may be implemented in diverse general-purpose or special-purpose computing systems. For example, the computing environment 900 can be any of a variety of computing devices (e.g., desktop computer, laptop computer, server computer, tablet computer, etc.).

With reference to FIG. 9, the computing environment 900 includes one or more processing units 910, 915 and memory 920, 925. In FIG. 9, this basic configuration 930 is included within a dashed line. The processing units 910, 915 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 9 shows a central processing unit 910 as well as a graphics processing unit or co-processing unit 915. The tangible memory 920, 925 may be volatile memory (e.g., registers, cache, RAM), non-volatile memory (e.g., ROM, EEPROM, flash memory, etc.), or some combination of the two, accessible by the processing unit(s). The memory 920, 925 stores software 980 implementing one or more innovations described herein, in the form of computer-executable instructions suitable for execution by the processing unit(s).

A computing system may have additional features. For example, the computing environment 900 includes storage 940, one or more input devices 950, one or more output devices 960, and one or more communication connections 970. An interconnection mechanism (not shown) such as a bus, controller, or network interconnects the components of the computing environment 900. Typically, operating system software (not shown) provides an operating environment for other software executing in the computing environment 900, and coordinates activities of the components of the computing environment 900.

The tangible storage 940 may be removable or non-removable, and includes magnetic disks, magnetic tapes or cassettes, CD-ROMs, DVDs, or any other medium which can be used to store information in a non-transitory way and which can be accessed within the computing environment 900. The storage 940 stores instructions for the software 980 implementing one or more innovations described herein.

The input device(s) 950 may be a touch input device such as a keyboard, mouse, pen, or trackball, a voice input device, a scanning device, or another device that provides input to the computing environment 900. The output device(s) 960 may be a display, printer, speaker, CD-writer, or another device that provides output from the computing environment 900.

The communication connection(s) 970 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

### ALTERNATIVES AND VARIATIONS

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions or a computer program product stored on one or more computer-readable storage media (e.g., non-transitory computer-readable media, such as one or more optical media discs such as DVD or CD, volatile memory components (such as DRAM or SRAM), or nonvolatile memory components (such as flash memory or hard drives)) and executed on a computer (e.g., any commercially available computer, including smart phones or other mobile devices that include computing hardware). By way of example and with reference to FIG. 9, computer-readable storage media include memory 920, memory 925, and/or storage 940. The term computer-readable storage media does not include signals and carrier waves. In addition, the term computer-readable storage media does not include communication connections (e.g., 970).

Any of the computer-executable instructions for implementing the disclosed techniques as well as any data created and used during implementation of the disclosed embodiments can be stored on one or more computer-readable storage media (e.g., non-transitory computer-readable media). The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

The disclosed methods, apparatus, and systems should not be construed as limiting in any way. Instead, the present disclosure is directed toward all novel and non-obvious features and aspects of the various disclosed embodiments, alone and in various combinations and sub-combinations with one another. The disclosed methods, devices, and systems are not limited to any specific aspect or feature or combination thereof, nor do the disclosed embodiments require that any one or more specific advantages be present or problems be solved. In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope of these claims.

We claim:

1. A system comprising:
a data store comprising a plurality of content items, the content items comprising elements of interactive pages of a software application, a respective content item being generated by a user of a community of users; and
a processor configured to:
for the community of users:
generate a base influence score of a respective user based at least on types and quantities of content items generated by the respective user, the base influence score adjusted to account for self-referential content items within the content items generated by the respective user;
generate an interactive influence score of the respective user based on content items associated with the respective user but not generated by the respective user; and
generate an influence score of the respective user by combining the base influence score and the interactive influence score; and
provide a relative measure of influence for at least one of the users of the community of users based on the generated influence scores.

2. The system of claim 1, wherein generating the base influence score of the respective user comprises assigning a weight to each content item generated by the respective user and summing the weights for all of the content items generated by the respective user.

3. The system of claim 2, wherein the weight assigned to each content item is based on the type of the content item, and the weight for a given type of content item is adjusted dynamically according to a relative frequency of the given type of content item.

4. The system of claim 2, wherein the weight assigned to each content item is adjusted based on a measured sentiment of the content item.

5. The system of claim 2, wherein the weight assigned to each content item is based on a property of the user that generated the content item.

6. The system of claim 5, wherein the property of the user is selected from one or more of a level in an organization, a number of followers, or a score based on a social interaction graph.

7. The system of claim 1, wherein a given type of content item is assigned an initial weight, and adjusting the base influence score to account for self-referential content items comprises reducing the initial weight of the given content item that is generated by the respective user and a child of another content item that is generated by the respective user.

8. The system of claim 1, wherein the relative measure of influence for a given user of the community of users is adjusted to account for a history of the given user within the community of users.

9. A method for providing influence analysis, the method comprising:
identifying content items matching one or more search criteria, the content items comprising first-user-generated content items generated by a first user and other-user-generated content items generated by users other than the first user;
determining a base influence score of the first user based at least on types and quantities of the first-user-generated content items, the base influence score dampened to account for self-referential content items within the first-user-generated content items;
determining an interactive influence score of the first user based on other-user-generated content items descending from the first-user-generated content items; and
combining the base influence score and the interactive influence score to create an influence score of the first user.

10. The system of claim 9, wherein generating the base influence score of the first user comprises assigning a weight to each content item generated by the first user and summing the weights for all of the content items generated by the first user.

11. The system of claim 10, wherein the weight assigned to each content item is based on the type of the content item, and the weight for a given type of content item is adjusted dynamically according to a relative frequency of the given type of content item, the weight being inversely proportional to the relative frequency of the given type of content item.

12. The system of claim 10, wherein the weight assigned to each content item is scaled according to a measured sentiment of the content item.

13. The system of claim 10, wherein the weight assigned to each content item is scaled according to a level of the first user within a hierarchy of an organization of the users.

14. The system of claim 10, wherein the weight assigned to each content item is scaled according to a level of interaction as measured using a social interaction graph.

15. The system of claim 9, wherein a given type of content item is assigned an initial weight, and dampening the base influence score to account for self-referential content items comprises reducing the initial weight of the given content item that is generated by the first user and a child of another content item that is generated by the first user.

16. The system of claim 9, wherein the influence score of the first user is adjusted to account for earlier influence scores of the first user.

17. The system of claim 9, wherein determining the interactive influence score of the first user comprises weighting other-user-generated descendant content items closer to the first-user-generated content items higher than other-user-generated descendant content items farther from the first-user-generated content items.

18. A computer readable storage medium storing computer-executable instructions that when executed perform a method, the method comprising:
receiving one or more search criteria;
identifying content items matching the one or more search criteria, the content items generated by a community of users of a collaborative software application;
providing a relative measure of activity for a given user of the community of users based at least on types and quantities of content items generated by the given user within the identified content items and interactions related to the content items generated by the given user, the relative measure of activity for the given user reduced to account for self-referential content items within the content items generated by the given user.

19. The computer readable storage medium of claim 18, wherein providing the relative measure of activity for the given user comprises generating a data structure for a content item generated by the given user, the data structure including a root node corresponding to the content item generated by the given user and one or more descendent nodes corresponding to content items generated by the other users in response to the content item generated by the given user.

20. The computer readable storage medium of claim 18, wherein providing the relative measure of activity for the given user comprises generating a social interaction graph where nodes of the graph correspond to users of the community of users and edges of the graph correspond to interactions among the users of the community of users.
